(19) United States
(12) Patent Application Publication
(10) Pub. No.: US 2007/0288388 A1
(43) Pub. Date: Dec. 13, 2007

(54) Method of selling plastic material

(76) Inventor: Beth Eckenrode, Presto, PA (US)

Correspondence Address: NOVA Chemicals Inc., Westpointe Center, 1550 Coraopolis Heights Road, Moon Township, PA, 15108, US

(21) Appl. No.: 11/448,997

(22) Filed: Jun. 7, 2006

(51) Int. Cl. H04L 9/00

(52) U.S. Cl. 705/59

(57) ABSTRACT

In accordance with the present invention, there is provided a method of conducting business that involves a supplier selling plastic material to at least two converters. The method, more particularly, involves forming a network that includes a supplier of plastic materials, and a plurality of converters each agreeing to purchase at least one plastic material from the supplier. The supplier takes a license for an item of intellectual property from an intellectual property owner, and then sublicenses the item of intellectual property to the converters. The supplier collects royalties from the converters for their use of the sublicensed intellectual property. A portion of the collected royalties are retained by the supplier, and the remainder is forwarded to the intellectual property owner. In a further embodiment of the invention, the supplier collects at least one idea from one or more of the converters in the network, and transforms the idea into an item of intellectual property, which the supplier then licenses to the converters in the network. The supplier: collects royalties from each converter relative to their use of the item of intellectual property licensed to them; retains a first portion of the royalties; and forwards a second portion of the royalties to each converter that provided the idea, which was transformed by the supplier into the item of intellectual property.

### FIELD OF THE INVENTION

The present invention relates to a method of conducting business, which involves a supplier selling a plastic material to two or more converters. The method, more particularly, involves forming a network that includes a supplier of plastic materials, and a plurality of converters who agree to purchase at least one plastic material from the supplier. The supplier takes a license for an item of intellectual property from an intellectual property owner, and then sublicenses the item of intellectual property to the converters. The supplier collects royalties from the converters for their use of the sublicensed intellectual property. A portion of the collected royalties are retained by the supplier, and the remainder is forwarded to the intellectual property owner.

### BACKGROUND OF THE INVENTION

In the plastics industry, typically a supplier sells a plastic material, such as a plastic raw material, to one or more converters (e.g., molders) who convert the plastic material into a product (e.g., a molded article). The converters usually prepare the product under contract for a customer, who then further distributes and/or sells the product to an end user.

In some instances, the product and/or the process by which the product is prepared is the subject of intellectual property, e.g., a patent, owned by a party that is other than the supplier. The intellectual property owner, if not practicing their own intellectual property, typically desires to license the intellectual property as widely as possible, so as to maximize a royalty income stream. However, if the intellectual property owner does not have access to potential licensees, for example, due to a lack of resources or limited market knowledge, then they may not be able to achieve a desired level of royalty income.

Many converters, such as molders, often have relatively small operations that serve a limited geographic or regional market. The geographic market of a converter may be further limited if they produce products that cannot be cost effectively shipped over long distances. Converters typically desire to maximize the output of their operations, but may be frustrated in doing so when serving a limited geographic market. In addition, if a converter does not have an opportunity to take a license to practice certain processes or make certain products, then their ability to maximize the output of their operations may be further or alternatively frustrated.

Suppliers of plastic materials generally want to maximize the amount of plastic material they sell. If a converter, however, to whom the supplier sells his plastic materials is not able to maximize the output of their operation, then the supplier may not be able to maximize the amount of plastic material sold.

It would be desirable to develop a business method that allows a supplier of plastic material to sell more plastic material to converters. It would be further desirable that such a new business method also provide an opportunity for converters to make more product, and owners of applicable intellectual property to increase their royalty income.

U.S. Pat. Nos. 6,542,871 B1 and 6,859,782 B2 disclose a method of developing new products for introduction into the market place. The method of US '871 and US '782 involves submitters submitting ideas (including concepts and partially developed products) into pools. The submitted ideas are registered, and after a pool reaches a predetermined number of registered ideas, a manager evaluates the marketability, patentability and technical feasibility of the registered ideas and selects at least one idea for product development and market introduction. Product development is funded by registration fees paid by the submitters. Developed products are licensed to a manufacturer, and royalties are collected by the manager and distributed to the submitter of the selected idea and the other submitters to the pool.

### SUMMARY OF THE INVENTION

In accordance with the present invention, there is provided a business method comprising:
(a) forming a network comprising,
   (i) a supplier of at least one plastic material, and
   (ii) a plurality of converters, each converter agreeing to purchase at least one plastic material from said supplier;
(b) taking a license, by said supplier, for an item of intellectual property from an intellectual property owner, said intellectual property owner being other than said supplier;
(c) sublicensing, by said supplier, said item of intellectual property to each converter;
(d) collecting, by said supplier, royalties from each converter for each converter's use of said item of intellectual property sublicensed to them;
(e) retaining, by said supplier, a first portion of royalties; and
(f) forwarding, by said supplier, a second portion of royalties to said intellectual property owner.

In further accordance with the present invention, there is also provided a business method comprising:
(a) forming a network comprising,
   (i) a supplier of at least one plastic material, and
   (ii) a plurality of converters, each converter agreeing to purchase at least one plastic material from said supplier;
(b) collecting, by said supplier, at least one idea from at least one of said plurality of converters;
(c) transforming, by said supplier, said idea into an item of intellectual property;
(d) licensing, by said supplier, said item of intellectual property to said plurality of converters,
(e) collecting, by said supplier, royalties from each converter for each converter's use of said item of intellectual property licensed to them;
(f) retaining, by supplier, a first portion of royalties; and
(g) forwarding, by the supplier, a second portion of royalties to each converter that provided said idea to said supplier.

The features that characterize the present invention are pointed out with particularity in the claims, which are annexed to and form a part of this disclosure. These and other features of the invention, its operating advantages and the specific objects obtained by its use will be more fully understood from the following detailed description.

Unless otherwise indicated, all numbers or expressions, such as those expressing structural dimensions, process conditions, etc., used in the specification and claims are understood as modified in all instances by the term “about.”

### DETAILED DESCRIPTION OF THE INVENTION

The method of the present invention involves the formation of a network. The network includes a supplier of at least one plastic material, and two or more converters. The supplier may be a single supplier, or two or more suppliers working together. In an embodiment of the present invention, the supplier is a single supplier. The network is typically formed by or under the initiative of the supplier. Alternatively, the network may be formed under the initiative of one or more converters, or one or more converters in conjunction with the supplier.

As used herein and in the claims, the term “converter” means an entity (e.g., an individual, partnership or company) that uses a plastic material to produce a product (e.g., a molded article, coating or coated article) that may contain the plastic material. The plastic material may be present in the final product in a modified or unmodified form. For example, in the case of a thermoplastic resin, the molded article prepared therefrom will typically contain the thermoplastic resin. When the plastic material is a crosslinker (e.g., a multifunctional isocyanate), the molded article may include the crosslinker in a modified form (e.g., a multifunctional carbamate in the case of a multifunctional unblocked isocyanate crosslinker).

In an embodiment of the method of the present invention, each converter is a manufacturer that practices a plastic molding method, such as thermoplastic molding methods and/or thermosetting molding methods (e.g., reaction injection molding). In particular, the molding method may be a thermoplastic molding method including, for example, injection molding, compression molding, vacuum molding, rotational molding, blow molding, thermoforming and combinations thereof.

The plastic material that is sold by the supplier to the converters includes, but is not limited to, thermosetting resin components, thermosetting resin compositions, thermoplastic resins, thermoplastic resin compositions, and/or additives that may be used with thermosetting and/or thermoplastic resins and resin compositions. The converters may purchase the plastic material directly from the supplier or from an intermediate party, such as a distributor.

Examples of thermosetting resin components include, but are not limited to, polymers or oligomers that include active or crosslinkable groups, and crosslinkers that include active or crosslinkable groups. Crosslinkable groups include, for example, isocyanate groups, blocked isocyanate groups (e.g., carbamates), oxirane groups, and ethylenically unsaturated groups, such a (meth)acrylates and allyl groups. Active groups react with crosslinkable groups to form covalent bonds (or crosslinks), and include, for example, active hydrogen groups, such as hydroxyls, thiols, primary amines and secondary amines. In some instances, a crosslinkable group is able to crosslink with itself. For example, isocyanates in the presence of appropriate catalysts and under proper conditions, may react together to form isocyanurates and biurettes, as is known to the skilled artisan. In addition, ethylenically unsaturated groups, such as allyl groups, are capable of forming covalent bonds with each other in the presence of appropriate catalysts and under proper conditions, as is known to the skilled artisan. After completion of the crosslinking reaction, e.g., between a thermosetting resin and a crosslinker, a three dimensional crosslink network of covalent bonds is formed. The resulting crosslinked reaction product or thermoset resin, while having a glass transition temperature, typically does not have a melting point.

Thermosetting resin compositions typically include one or more thermosetting resin components, e.g., polymers or oligomers that include active, and crosslinkers that include crosslinkable groups. Generally, there are two classes of thermosetting resin compositions: one pack or storage stable thermosetting resin compositions; and two pack or storage unstable thermosetting resin compositions. The components of a two pack thermosetting resin composition (e.g., resin having active groups, crosslinkers having crosslinkable groups, and optionally catalysts) are typically combined together shortly prior to use, to avoid premature gelling and/or setting of the composition. One pack thermosetting resin compositions generally include active and crosslinkable groups that do not react in the absence of certain conditions (e.g., exposure to elevated temperature and/or actinic light). An example of a one pack thermosetting resin composition includes resins having active groups (e.g., hydroxyl groups), and crosslinkers having blocked crosslinkable groups (e.g., isocyonate groups blocked with mono-functional alcohols). Upon exposure to elevated temperature, the blocking groups unblock from the isocyanate groups, and a crosslinking reaction ensues (e.g., between the hydroxyl groups of the resin and the free isocyanate groups of the unblocked crosslinker) thus resulting in the formation of a thermoset article.

Thermoplastic resins typically have both a glass transition temperature and a melting point, as is known to the skilled artisan. Examples of thermoplastic resins include, but are not limited to, thermoplastic polyurethanes, thermoplastic polyureas, thermoplastic polyimides, thermoplastic polyamides, thermoplastic polyamideimides, thermoplastic polyesters, thermoplastic polycarbonates, thermoplastic polysulfones, thermoplastic polyketones, thermoplastic poly(C₂-C₈)-alkylenes (e.g., polyethylene and polypropylene), thermoplastic acrylonitrile-butadiene-styrene, homopolymers thereof, copolymers thereof and combinations thereof.

Classes of additives that may be used with thermosetting and/or thermoplastic resins and resin compositions include, for example, pigments, dyes, optical brighteners, catalysts, stabilizers (e.g., light stabilizers, UV stabilizers and heat stabilizers), fillers and extenders (e.g., clays), reinforcing agents (e.g., fibers, such as glass or carbon fibers), flame retardants and plasticizers.

Each converter within the network agrees to purchase at least one plastic material from the supplier. The agreement between the supplier and the converters also includes an obligation on the part of the supplier to license at least one item of intellectual property from at least one intellectual property owner, and then sublicense that item of intellectual property to each converter.

The item of intellectual property may be any form of intellectual property, including for example, copyrights, trademarks, trade secrets, patents and combinations of two or more thereof. In an embodiment of the present invention, the item of intellectual property is selected from processes (e.g., molding processes), machines (e.g., molds and molding equipment), articles of manufacture (e.g., molded articles), compositions of matter (e.g., additives) and combinations thereof.

The plastic material sold by the supplier and purchased by the converters is generally not a subject of the item of intellectual property. For example, if the plastic material is a thermoplastic resin, such as polyethylene, the item of intellectual property would not generally cover the thermoplastic resin or a method of its preparation. In the case of the plastic material being a thermoplastic resin, the item of intellectual property may, for example, cover an article of manufacture that could be made from the thermoplastic material (e.g., a molded article), or a method of forming an article of manufacture, such as a molding process. In the idea transformation embodiment of the present invention, the plastic material is a subject of the item of intellectual property, as will be discussed in further detail herein.

The item of intellectual property is typically in a marketable form, which requires little or no modification prior to implementation by the converters. For purposes of comparison, and as used herein and in the claims, an “idea” is not in a reducible form (i.e., not capable of being reduced to practice) or a marketable form, and can not be implemented by the converters in the absence of transformation of the idea into an item of intellectual property, e.g., by means of research and development on the part of the supplier, as will be discussed in further detail herein.

The intellectual property owner is a party other than the supplier. In an embodiment of the present invention, the intellectual property owner would not license the item of intellectual property to all of the converters of the network, but for the existence of the network. The intellectual property owner may not be capable of licensing or desire to license the item of intellectual property to all of the converters. An intellectual property owner having limited financial resources, for example an independent inventor or small company, such as a start-up company, may not be able or desire to contact and/or negotiate licensing agreements with numerous converters. Negotiating separate licensing agreements with numerous individual converters who are spread across a wide geographic area, such as the United States of America and its territories, may be cost prohibitive or otherwise undesirable for an intellectual property owner. Alternatively, the intellectual property owner may not have knowledge of the converters. In the method of the present invention, the intellectual property owner need only negotiate and/or deal with the supplier as to licensing the item of intellectual property. The intellectual property owner may approach the supplier, and/or the supplier may seek out the intellectual property owner for purposes of licensing the item of intellectual property, in the method of the present invention. The license from the intellectual property owner to the supplier may be an exclusive or non-exclusive license.

In an embodiment of the present invention, the intellectual property owner is at least one of the plurality of the converters, but less than all of the converters. When the owner of the item of intellectual property is one of the converters, the item of intellectual property is sublicensed by the supplier to each converter who is not an owner of the item of intellectual property. An intellectual property owner who is one of the converters within the network may be motivated to license his intellectual property to the supplier if the licensing converter is not practicing the intellectual property, and would desire to obtain a royalty income stream therefrom. In addition to gaining royalties, one of the converters in the network may be motivated to license his item of intellectual property to the supplier for purposes of increasing demand for products resulting from use of the intellectual property by the other converters, and correspondingly increased demand for such products made by the converter who owns the item of intellectual property.

After the terms of the license between the intellectual property owner and the supplier are finalized, the supplier may then negotiate the terms of the sublicense(s) separately or collectively with the converters in the network. Alternatively, the terms of the sublicense may be finalized or set in advance, for example as part of a pre-existing network agreement between the supplier and the converters. Typically, the terms of the sublicense are the same for each converter. The sublicense between the supplier and the converters may be an exclusive or non-exclusive sublicense.

The sublicense from the supplier to the converters may allow or prevent the converters from further sublicensing the item of intellectual property. Typically, the sublicense from the supplier to the converters does not allow the converters to further sublicense the item of intellectual property.

The network may be formed prior to, after or concurrent with the supplier taking the license from the intellectual property owner. For example, the supplier and the intellectual property owner may negotiate the terms of a license, the finalization of which being contingent upon the supplier setting up the network. Alternatively, the network may be first set up (e.g., by means of an agreement between the supplier and the converters), and the supplier would then take a license from the intellectual property owner. Still further alternatively, at least two of the following steps may be undertaken substantially concurrently: (i) negotiations towards the license between the intellectual property owner and the supplier; (ii) setting up the network; and (iii) negotiations between the supplier and the converters as to the sublicense.

Sublicensing the item of intellectual property by the supplier to the converters, allows each sublicensing converter to produce a product (e.g., a molded article). For example, the item of intellectual property may be for an article of manufacture (e.g., a molded article), a process of making an article (e.g., a molding process), or a machine used in a process (e.g., a mold). The product may include at least one plastic material purchased by each converter from the supplier, and/or the product is prepared with at least one plastic material purchased from the supplier, but the product does not necessarily include the plastic material as originally purchased. The plastic material may change physically and/or chemically during formation of the product. For example, in the case of a crosslinker, the crosslinker may be covalently bonded within the final product, and may change from a liquid to a solid during the crosslinking process. An antioxidant, for example, may be at least partially consumed and/or altered during a thermoplastic extrusion and molding process, and the molded article resulting from such process thus containing an altered form of the antioxidant.

The product including the supplier's plastic material (or an altered form thereof) that the item of intellectual property allows each converter to produce, may, in an embodiment of the present invention, be produced substantially uniformly by each converter within the network. When produced substantially uniformly, the product (e.g., a molded article) will typically have substantially uniform physical properties, including for example, density, color, dimensions, chemical resistance and impact resistance. Producing products substantially uniformly and correspondingly products having substantially uniform properties, may result in increased demand for such products by end users, due in part to improved reliability and/or predictability associated with the products. When the converters are spread across a wide geographic area, such as the United States of America, uniformly produced products having substantially uniform properties may further increase demand, because a product produced in one location (e.g., Florida) will be substantially the same as a product produced in a more distant location (e.g., Alaska). Increased demand for products across a wider geographic area, and increased revenue related thereto, may provide an intellectual property owner with further motivation to license their intellectual property to the supplier in the method of the present invention.

In the method of the present invention, the supplier collects royalties from each converter relative to their use of the item of intellectual property sublicensed to them. The royalties may be collected directly by the supplier or by an agent of the supplier. The converters may make: an upfront royalty payment (e.g., a single upfront royalty payment to the supplier); separate royalty payments to the supplier; or a combination thereof. Alternatively, the royalty payments may be built in to the cost of the plastic material, in which case royalties are paid to the supplier concurrently with the purchase of plastic material by the converters.

Depending on the terms of the sublicense agreement, the royalties may, for example, be based on the amount of plastic material purchased from the supplier, or on a unit basis, in which case the converters pay a royalty based on each unit of product produced and sold using the sublicensed intellectual property. The supplier retains a first portion of royalties, and forwards a second portion of royalties to the intellectual property owner. Depending on the terms of the licensing agreement between the intellectual property owner and the supplier, the first portion of royalties (retained by the supplier) may be less than, equal to, or greater than the second portion of royalties (forwarded to the intellectual property owner). For example, the first portion of royalties may range from 1 percent to 99 percent, 20 percent to 80 percent, or 40 percent to 60 percent, based on the total amount of royalties; and correspondingly the second portion of royalties may range from 1 percent to 99 percent, 20 percent to 80 percent, or 40 percent to 60 percent, based on the total amount of royalties. Typically, the first portion of royalties is less than the second portion of royalties, and ranges from 1 percent to 45 percent, 5 percent to 40 percent, or 10 percent to 30 percent, based on the total royalties; and correspondingly the second portion of royalties ranges from 55 percent to 99 percent, 60 percent to 95 percent, or 70 to 90 percent, based on the total royalties.

Typically, the second portion of royalties are periodically forwarded to the intellectual property owner by the supplier, after the supplier has collected royalty payments from the converters. In an alternative embodiment of the present invention, all or a portion of the second portion of royalties are forwarded by the supplier to the intellectual owner prior to receipt of royalties by the supplier from the converters. For example, all or a portion of the second portion of royalties may be paid/forwarded by the supplier to the intellectual owner as an up-front licensing fee, prior to the collection of any royalties by the supplier from the converters.

In the method of the present invention, the supplier provides one or more additional services to the converters. These additional services may be provided prior to sublicensing the item of intellectual property to the converters (e.g., as an incentive to take the sublicense). Typically, the additional services are provided after the item of intellectual property has been sublicensed to the converters. These additional services provided by the supplier may include, but are not limited to: providing marketing analysis results to the converters; developing at least one new market for at least one of the converters; promoting a product made by at least one converter; and/or providing technical support for the sublicensed item of intellectual property to at least one of the converters. These services are typically provided for purposes of increasing the converters' use of the sublicensed item of intellectual property, and correspondingly the converters' purchase of plastic material from the supplier.

The marketing analysis provided by the supplier is typically directed to a market in which products produced by the converters (using the sublicensed item of intellectual property) will likely be or are presently being sold. Marketing analysis results may include, but are not limited to, customer needs, projected growth, trends, transportation requirements, customer identification and/or product pricing limits associated with a particular market relative to a particular product(s).

Developing a new market by the supplier may involve identifying a potential market, obtaining or performing marketing analysis, identifying a strategy, engaging in promotional activities, such as distributing free samples, and placing potential customers in contact with the converters in the network. The supplier typically will employ its current sales and marketing assets in the course of performing the market development service.

The supplier may promote a product made by at least one converter by displaying the product at a tradeshow, or arranging for another party to do so. The supplier may also promote the product by means of its sales force, and/or published articles in trade journals.

The supplier may provide technical support to better ensure that the sublicensed intellectual property is quickly and effectively implemented by the converters, thus increasing the amount of plastic material sold to the converters. Technical support may include, for example, process design, mold design, extruder and mold operation advice, process implementation, and analytical services (including, for example, physical and chemical analysis of molded articles and/or feed stocks).

Each converter generally has a geographic market which they serve. The geographic market of one converter may overlap at least a portion of the geographic market of another converter. If there is overlap between the geographic markets of any two converters, the overlap is usually, but not necessarily, less than total (e.g., less than 50 percent or less than 25 percent overlap, based on the total geographic market of both overlapping converters).

In some instances, at least one converter may have a geographically limited or distinct market relative to at least one of their manufacturing (or production) facilities. As used herein and in the claims, the term “geographically limited (or distinct) market” means that a particular converter does not ship at least one product they produce beyond a certain radius or distance from at least one of their manufacturing facilities. A converter may not ship a product beyond a particular distance from their manufacturing facility for reasons including, but not limited to, prohibitively high shipping costs, and one or more customers that are located relatively close to their manufacturing facility. For example, a converter may sell all of a particular product it makes (e.g., to capacity) to a customer located across the street or within the same city, and as such does not need to ship the product beyond that point.

In an embodiment of the present invention, at least one converter produces a product, which incorporates the item of intellectual property, and which is economically costly to ship, and each converter that produces the product has a geographically limited (or distinct) market as to that product relative to at least one of their manufacturing/production facilities. The shipping costs associated with the product may be prohibitively high due, for example, to the size and/or weight of the product.

For purposes of illustration, a converter that is a manufacturer practicing a thermoplastic molding method, such as rotational molding, may produce large molded articles, such as thermoplastic dumpsters (e.g., having an internal volume of 2-6 yard³, i.e., 1.5-4.6 m³). Due to their relatively large size, only a limited number of the thermoplastic dumpsters may be shipped per transportation vehicle, such as a truck or rail car. As a result, shipping costs must be spread over fewer units, and, accordingly, the shipping costs per dumpster unit increase, thus limiting the distance that the dumpsters may be cost effectively shipped from the converter's manufacturing facility. Alternatively, or in addition to the issue of size, if the weight of a product fabricated by a converter is high, the shipping costs per unit increase, thus limiting the distance from the converter's manufacturing facility, that the unit may be cost effectively shipped.

In an embodiment of the present invention, the geographically limited or distinct market that a converter may serve (due, for example, to prohibitively high shipping costs) has an area from 31,000 square miles to 283,000 square miles, inclusive (80,290 square kilometers to 732,967 square kilometers), or from 31,000 square miles to 125,664 square miles (80,290 square kilometers to 325,468 square kilometers). The area of the limited geographic market is estimated by taking the furthest distance that a converter will ship a particular item from a particular manufacturing facility, as being the radius of a circle. For example, a geographically limited area of 31,000 square miles (80,290 km²) to 283,000 square miles (732,967 km²) corresponds to a shipping distance or radius (from the converter's manufacturing facility) of 100 miles to 300 miles (161 km to 483 km). A geographically limited area of 31,000 square miles (80,290 km²) to 125,664 square miles (325,468 km²), corresponds to a shipping distance or radius, from the converter's manufacturing facility, of 100 miles to 200 miles (161 km to 322 km).

In the method of the present invention, a converter may have a geographically exclusive market, relative to at least one of their manufacturing or production facilities. A geographically exclusive market typically has less than or equal to 25 percent area overlap, less than or equal to 15 percent area overlap or less than or equal to 10 percent area overlap with the geographic market of one or more other converters in the network, based on the total area of the overlapping geographic markets. A geographically exclusive market may be substantially free of overlap with the geographic market of any other (i.e., all other) converters in the network (e.g., having 0 percent area overlap with the geographic market of one or more other converters in the network).

A geographically exclusive market may optionally also be a geographically limited market, and vice versa. Typically, a geographically exclusive market is also a geographically limited market. A geographically limited market is not, however, necessarily a geographically exclusive market. For example, while it may be cost prohibitive for a first converter to ship a particular product beyond a certain point, it may not be cost prohibitive for a second converter to ship the same product into at least a portion of the first converter's geographically limited market (e.g., due to proximity of the two converters' manufacturing facilities or differing economies of scale). In such a case, the first converter has a geographically limited market, but not a geographically exclusive market as to that particular product.

In the method of the present invention, at least one, and in particular each converter in the network has a geographically exclusive market relative to at least one production/manufacturing facility, and the plurality of converters together have a combined geographic market that is larger than the geographically exclusive market of any one converter. In such a situation, the intellectual property owner may be able to realize a wider geographic distribution of his item of intellectual property by means of the network and a corresponding increase in royalties, than would be realized by licensing the item of intellectual property to less than all of the converters (e.g., a single converter). At the same time, the converters may realize increased demand for products they produce which incorporate the item of intellectual property, because it is available over a larger geographic market. Correspondingly, the supplier may realize an increase in the sale of plastic material to the converters in the network.

In an embodiment of the present invention, each converter has a geographic market, which may also be a geographically exclusive market and/or a geographically limited market, or neither a geographically exclusive market nor a geographically limited market. At least one converter, and less than all of the converters, may refuse to sublicense the item of intellectual property, in which case the method of the present invention further comprises redistributing at least a portion of the refusing sublicensee's geographic market amongst (or to) one or more of those converters who have sublicensed the item of intellectual property (i.e., the sublicensing converters, or accepting sublicensees), but only as to that item of intellectual property. The refusing sublicensee's geographic market may be redistributed to (or amongst) one or more, but typically less than all of the accepting sublicensees. For example, some of the accepting sublicensees may not wish to ship product into the refusing sublicensee's geographic market, for reasons including, for example, prohibitively high shipping costs and lack of surplus capacity.

For purposes of illustration, a converter within the network may not be able or wish to take a sublicense to a particular item of intellectual property for reasons including, but not limited to, a lack of surplus capacity, for want of proper machinery, local environmental regulations and/or conflicts arising from contractual arrangements with other parties. When one or more converters is a refusing sublicensee, the remaining accepting licensees, the supplier and the intellectual property owner have an interest in distributing product incorporating the item of intellectual property into the refusing sublicensee's geographic market, for purposes of maximizing product orders for the sublicensing converters, sale of plastic material by the supplier to the sublicensing converters and royalties paid to the intellectual property owner. The geographic market redistribution step/option may be agreed to in advance in the network agreement between the supplier and the converters, and/or in the sublicense contract between the supplier and the converters.

The item of intellectual property licensed from the intellectual property owner may be transformed by the supplier into a transformed item of intellectual property, in the method of the present invention. The transformed item of intellectual property is then sublicensed by the supplier to the converters in the network. Transforming the item of intellectual property is typically undertaken by the supplier for purposes of rendering the original item of intellectual property more readily applicable to the converters. For example, an original item of intellectual property in the form of a molding method may include a step (e.g., a vacuum extrusion step) that is not easily utilized by the converters. Transformation of the original molding method by the supplier (e.g., by modifying a step, including further steps and/or changing feed stocks used in a particular step) may serve to provide a transformed method that is more readily utilized by the converters.

A transformed item of intellectual property, in the present invention, typically retains some aspect or elements of the original item of intellectual property, but further includes at least one additional element and/or at least one modified original element. For purposes of illustration, when the original item of intellectual property is a method comprising, for example, steps (a) through (d), the transformed item of intellectual property may include: original steps (a) through (c) and a modified step (d); original steps (a) through (d) and a new step (e); and/or original steps (a) through (c), a modified step (d), and a new step (e). Similarly, when the original item of intellectual property is an article of manufacture comprising elements (a) through (d), the transformed item of intellectual property may include, for example: original elements (a) through (c) and a modified element (d); original elements (a) through (d) and a new element (e); and/or original elements (a) through (c), a modified element (d), and a new element (e).

In the case of an original expression of an underlying idea that is fixed in a tangible medium, the transformed item of intellectual property may be a derivative work prepared by the supplier, with permission from the intellectual property owner. With a trademark, the transformed item of intellectual property may be a modified mark including, for example, different colors, fonts, modified terms and/or different terms, prepared by the supplier with permission of the intellectual property owner.

In transforming the original item of intellectual property, the supplier may employ its present in-house assets, such as its present in-house research and development assets and/or technical service assets. Alternatively, the supplier may contract with a third party to transform the item of intellectual property. Typically, the supplier makes use of its present in-house assets in transforming the item of intellectual property.

Ownership of the transformed item of intellectual property may reside with the owner of the original item of intellectual property and/or the supplier. Typically, ownership of the transformed item of intellectual property resides at least partially with the owner of the original item of intellectual property. The costs of transforming the original item of intellectual property may be born solely by the supplier or the owner of the original item of intellectual property, or shared by the supplier and the owner of the original item of intellectual property. For example, at least a portion of the costs of transforming the original item of intellectual property may be deducted from the second portion of royalties forwarded to the intellectual property owner, and the first portion of royalties retained by the supplier may be correspondingly increased. The costs of transforming the item of intellectual property may be addressed in the licensing agreement and/or in a separate agreement between the owner of the original item of intellectual property and the supplier.

The supplier may, in the method of the present invention, obtain proprietary protection for the item of intellectual property, which is licensed from the intellectual property owner, or the transformed item of intellectual property. The form of proprietary protection may include, for example, copyright protection, trademark protection, patent protection and/or trade secret protection. The proprietary protection may be owned by the intellectual property owner and/or the supplier. Typically, the proprietary protection will be at least partially owned by the intellectual property owner.

In the case of trade secret protection, the step of obtaining proprietary protection typically involves maintaining the item of intellectual property or the transformed item of intellectual property as a trade secret. For example, in the case of a proprietary method, the supplier could incorporate confidentiality provisions into the sublicensing contract(s) and/or the network agreement with the converters, thereby maintaining the proprietary method as a trade secret.

The item or transformed item of intellectual property may have associated therewith various forms of original expression that are fixed in a tangible medium, such as product literature, which the supplier may seek to protect by means of one or more copyrights. Likewise, the item or transformed item of intellectual property may have one or more marks associated therewith, which the supplier may seek to protect by means of at least one state and/or federal trademark.

The item or transformed item of intellectual property may be patentable, in which case the supplier may seek to secure at least one patent in at least one country (e.g., the U.S.) therefore. Typically, the patent would be a utility and/or design patent, and more typically a utility patent (e.g., drawn to a process or article of manufacture). The supplier may use its own in-house patent counsel and/or outside patent counsel in the preparation, filing and prosecution of the patent application, and optionally maintenance and enforcement of any patent(s) granted thereon.

Costs associated with the supplier obtaining one or more forms of proprietary protection for the item or transformed item of intellectual property may be born solely by the supplier or solely by the intellectual property owner, or shared by the supplier and the intellectual property owner. For example, at least a portion of the costs of obtaining proprietary protection may be passed directly on to the intellectual property owner, such as in the form of invoices. Alternatively or in addition thereto, such costs may be deducted from the second portion of royalties that are forwarded to the intellectual property owner by the supplier, in which case, the first portion of royalties retained by the supplier would be correspondingly increased.

The present invention also provides for a method in which the supplier collects at least one idea from at least one of the plurality of converters in the network. The supplier then transforms the idea into an item of intellectual property, which the supplier then licenses to the converters in the network. The supplier collects royalties from each converter relative to their use of the item of intellectual property licensed to them. The supplier retains a first portion of the royalties, and forwards a second portion of the royalties to each converter that provided the idea, which the supplier transformed into an item of intellectual property.

As used herein and in the claims, the term “idea” means a concept, thought or notion that alone without further modification, transformation and/or conversion can not be constructively or, in particular, actually reduced to practice. The term “idea” is distinguishable from the term “item of intellectual property” in that an item of intellectual property is in a form that may be constructively or, in particular, actually reduced to practice.

For example, an idea as to a general method of forming a molded plastic article that does not embody a complete conceptualization of the method of formation (e.g., missing one or more key or critical method steps), could not be reduced to practice, and would require further work to render the method complete and reducible to practice, in which case the idea would be transformed into an item of intellectual property. For purposes of further illustration, the idea may relate to a particular molded article, but without a complete conceptualization as to how the molded article would be prepared, in which case, the supplier would develop the method of preparation thus transforming the idea into an item of intellectual property. Alternatively, the idea may relate to a molded article, but without a complete conceptualization as to the full design of the molded article (e.g., a particular molded container having a particular lid, but without a conceptualization as to reversibly attaching the lid to the container). The supplier would, for example, develop a full design of the molded article (e.g., including reversible attachment of the lid to the container), thereby transforming the idea into an item of intellectual property. Still further, the idea may relate to a problem faced by one or more of the converters in their manufacturing processes, but expressed with less than a total conceptualization as to how to solve the process related problem. The supplier, may then develop a procedure, process modification, machine and/or article of manufacture that would address or solve the converter's process problem, thereby transforming the converter's idea into an item of intellectual property.

The item of intellectual property resulting from the idea transformation step may be owned by the supplier, owned by the converter(s) that submitted the idea, or jointly owned by the supplier and the submitting converter(s). Ownership of the item of intellectual property may be agreed to in advance, for example, in a network agreement between the supplier and the converters. Alternatively, ownership of the resulting item of intellectual property may be negotiated between the supplier and the submitting converter on a case-by-case basis. Typically, the supplier will have at least partial ownership of the resulting item of intellectual property, due to the resources expended by the supplier in the course of the idea transformation step.

The ideas may be collected by the supplier, from the converters, directly or indirectly. Direct collection of the ideas, typically involves the converters providing their ideas directly to the supplier, who then collects and optionally sorts and evaluates the ideas. The ideas may be collected directly by the supplier in either a tangible format (e.g., writings on paper) or a digital format (e.g., writings in the form of e-mails or attachments to e-mails).

Indirect collection of the ideas may be achieved by means of a third party and/or a database. A third party may collect, and optionally sort and evaluate the ideas, and then forward the ideas, optionally with an accompanying report, to the supplier. The third party and/or the supplier may employ a database in the indirect collection process. Preferably, the database is an automated database, which is under the supplier's control, and into which the converters remotely submit their ideas, for example by means of a computer interface. The computer interface typically involves a secured portal (e.g., a secured internet portal), which the converters have password protected access to. The database may include various fields that the converter fills in during the idea submission process. Non-limiting examples of database fields include: categories of ideas, such as processes, articles of manufacture, machines, designs and/or trademarks; a description of the idea itself; the identity of the submitting converter; date of submission; names of those individuals who came up with the idea; and the date on which and the place where the idea occurred to them. The fields may be used, for example by the supplier, to sort, manage and evaluate the submitted ideas.

After collection of the ideas, the supplier then transforms at least one idea into an item of intellectual property, as discussed previously herein. The transformation step may involve the supplier subjecting the idea to research and development. Research and development typically involves, as is known to the skilled artisan: setting up and running one or more experimental regiments; evaluating the results thereof; identifying at least one practicable platform (e.g., a particular process, product design or machine); and further developing the practicable platform (e.g., optimizing process parameters, design specifications and/or materials selection). The developed platform typically represents the item of intellectual property.

In an embodiment of the present invention, the idea transformation step involves the supplier: (i) evaluating at least one idea collected from at least one of the converters; (ii) identifying, from the evaluated ideas, at least one viable idea; and (iii) subjecting the viable idea to research and development, thereby transforming the viable idea into the item of intellectual property. Evaluation of the ideas typically involves the supplier first sorting the submitted ideas by category, such as, processes and molded article designs. The sorted ideas may then be prioritized by the supplier with regard to, for example, market needs, converter production capabilities and capacities (including equipment availability), the supplier's research and development capabilities, the supplier's plastic material portfolio, the estimated amount of investment (in time and money) to transform the idea, and combinations thereof. Sorted ideas having a high priority may then be identified as viable ideas, which are then subjected to research and development and thus transformed into one or more items of intellectual property, as described previously herein.

The supplier then licenses the item of intellectual property (resulting from the idea transformation step) to the converters in the network. The terms of the license(s) may be negotiated separately or collectively with the converters in the network. Alternatively, the terms of the license may be finalized or set in advance, for example as part of a pre-existing network agreement between the supplier and the converters. Typically, the terms of the license are the same for each converter (i.e., those converters who did not submit the idea). The license between the supplier and the converters may be an exclusive or non-exclusive license.

The license from the supplier to the converters may allow or prevent the converters from sublicensing the item of intellectual property. Typically, the license from the supplier to the converters does not allow the converters to sublicense the item of intellectual property.

The network formation, idea collection, idea transformation and licensing steps may be performed in any order, and at least two thereof may be performed concurrently, provided that the idea transformation step is performed either after or concurrently with the idea collection step. Typically, the network formation, idea collection, idea transformation and licensing steps are performed sequentially as recited. As discussed previously herein, the network may be formed at the initiative of the supplier, the initiative of one or more converters, or under the joint initiative of the supplier and at least one converter.

Licensing the item of intellectual property (resulting from the idea transformation step) by the supplier to the converters, allows each licensing converter to produce a product (e.g., a molded article). For example, the item of intellectual property may be for an article of manufacture (e.g., a molded article), a process of making an article (e.g., a molding process), or a machine used in a process (e.g., a mold). The product may include at least one plastic material purchased by each converter from the supplier, and/or the product is prepared with at least one plastic material purchased from the supplier, but the product does not necessarily include the plastic material as originally purchased. As discussed previously herein, the plastic material may change physically and/or chemically during formation of the product. For example, in the case of a crosslinker, the crosslinker may be covalently bonded within the final product, and may change from a liquid to a solid during the crosslinking process. An antioxidant, for example, may be at least partially consumed and/or altered during a thermoplastic extrusion and molding process, and the molded article resulting from such process containing an altered form of the antioxidant.

The product including the supplier's plastic material (or an altered form thereof) that the idea transformation generated item of intellectual property allows each converter to produce, may, in an embodiment of the present invention, be produced substantially uniformly by each converter within the network. As discussed previously herein, when produced substantially uniformly, the product (e.g., a molded article) will typically have substantially uniform physical properties, including for example, density, color, dimensions, chemical resistance and impact resistance. Producing products substantially uniformly and correspondingly products having substantially uniform properties, may result in increased demand for such products by end users, due in part to improved reliability and/or predictability associated with the products. When the converters are spread across a wide geographic area, such as the United States of America, uniformly produced products having substantially uniform properties may further increase demand, because a product produced in one location (e.g., Delaware) will be substantially the same as a product produced in a more distant location (e.g., Hawaii). Increased demand for products across a wider geographic area, and increased revenue related thereto, may provide a converter with further motivation to submit their idea(s) to the supplier in the method of the present invention.

In the method of the present invention, the supplier collects royalties from each converter relative to their use of the idea transformation generated item of intellectual property licensed to them. The converters may make: an upfront royalty payment (e.g., a single upfront royalty payment to the supplier); separate royalty payments to the supplier; or a combination thereof. Alternatively, the royalty payments may be built into the cost of the plastic material, in which case royalties are paid to the supplier concurrently with the purchase of plastic material by the converters.

Depending on the terms of the licensing agreement between the supplier and the converters, the royalties may, for example, be based on the amount of plastic material purchased from the supplier, or on a unit basis, in which case the converters pay a royalty based on each unit of product produced and sold using the licensed intellectual property. The supplier retains a first portion of royalties, and forwards a second portion of royalties to the converter or converters who submitted the idea that was transformed into the item of intellectual property.

The first portion of royalties (retained by the supplier), depending on the terms of the licensing agreement between the supplier and the converters, may be less than, equal to, or greater than the second portion of royalties (forwarded to each converter who submitted an idea that was subjected to transformation). For example, the first portion of royalties may range from 1 percent to 99 percent, 20 percent to 80 percent, or 40 percent to 60 percent, based on the total amount of royalties; and correspondingly the second portion of royalties may range from 1 percent to 99 percent, 20 percent to 80 percent, or 40 percent to 60 percent, based on the total amount of royalties.

In the idea transformation embodiment of the present invention, the first portion of royalties (retained by the supplier) is typically more than the second portion of royalties, because of the costs incurred by the supplier in transforming the idea into an item of intellectual property. As such, the first portion of royalties, in the idea transformation embodiment of the present invention, more typically ranges from 55 percent to 99 percent, 60 percent to 95 percent, or 70 to 90 percent, based on the total royalties; and correspondingly, the second portion of royalties ranges from 1 percent to 45 percent, 5 percent to 40 percent, or 10 percent to 30 percent, based on the total royalties.

The first portion of royalties (retained by the supplier) may be greater than the second portion of royalties when the plastic material sold by the supplier to the converters is a subject of the item of intellectual property resulting from the idea transformation step. When the plastic material sold by the supplier is a subject of the item of intellectual property, the supplier, while retaining a larger share of royalties (as the first portion), may still provide the idea submitting converter with the second portion of royalties as compensation for submitting the idea, and/or as an incentive to generate additional idea submissions by that converter and the other converters in the network.

Typically, the second portion of royalties are periodically forwarded by the supplier to the idea submitting converter(s), after the supplier has collected royalty payments from the other converters. In an alternative embodiment of the present invention, all or a portion of the second portion of royalties are forwarded by the supplier to the idea submitting converter prior to receipt of royalties by the supplier from the other converters. Further alternatively, the second portion of the royalties may be effectively provided in the form of a reduced price that the supplier charges the idea submitting converter for their purchase of plastic material from the supplier.

In the idea transformation embodiment of the present invention, the supplier may provide one or more additional services to the converters. These additional services may be provided prior to licensing the item of intellectual property to the converters (e.g., as an incentive to take the license). Typically, the additional services are provided after the item of intellectual property has been licensed to the converters. These additional services provided by the supplier may include, but are not limited to: providing marketing analysis results to the converters; developing at least one new market for at least one of the converters; promoting a product made by at least one converter; and/or providing technical support for the licensed item of intellectual property to at least one of the converters. These services are typically provided for purposes of increasing the converters use of the licensed item of intellectual property, and correspondingly the converters purchase of plastic material from the supplier. The additional services (e.g., new market development) may be described more particularly in accordance with those descriptions and examples provided previously herein.

In the idea transformation embodiment of the present invention, the geographic market, geographically limited (or distinct) market and geographically exclusive market of each converter may be described in accordance with the descriptions and examples provided relative thereto previously herein.

In the idea transformation embodiment of the present invention, at least one converter may produce a product, which incorporates the item of intellectual property, and which is economically costly to ship, and each converter that produces the product has a geographically limited (or distinct) market as to that product relative to at least one of their manufacturing/production facilities. The shipping costs associated with the product may be prohibitively high due, for example, to the size and/or weight of the product. For example, a converter that is a manufacturer practicing a thermoplastic molding method, such as rotational molding, may produce large molded articles, such as thermoplastic dumpsters (e.g., having an internal volume of 2-6 yard³, i.e., 1.5-4.6 m³). Due to their size, only a limited number of the thermoplastic dumpsters may be shipped per transportation vehicle, such as a truck or rail car. Accordingly, shipping costs must be spread over fewer units, and as a result the shipping costs per dumpster unit increase, thus limiting the distance that the dumpsters may be cost effectively shipped from the converter's manufacturing facility. Alternatively, or in addition to the issue of size, if the weight of a product fabricated by a converter is high, the shipping costs per unit increase, thus limiting the distance from the converter's manufacturing facility, that the unit may be cost effectively shipped.

In the idea transformation embodiment of the present invention, the geographically limited or distinct market that a converter may serve (due, for example, to prohibitively high shipping costs) has an area from 31,000 square miles to 283,000 square miles, inclusive (80,290 square kilometers to 732,967 square kilometers), or from 31,000 square miles to 125,664 square miles (80,290 square kilometers to 325,468 square kilometers). The area of the limited geographic market is estimated by taking the furthest distance that a converter will ship a particular item from a particular manufacturing facility, as being the radius of a circle. For example, a geographically limited area of 31,000 square miles (80,290 km²) to 283,000 square miles (732,967 km²) corresponds to a shipping distance or radius (from the converter's manufacturing facility) of 100 miles to 300 miles (161 km to 483 km). A geographically limited area of 31,000 square miles (80,290 km²) to 125,664 square miles (325,468 km²), corresponds to a shipping distance or radius, from the converter's manufacturing facility, of 100 miles to 200 miles (161 km to 322 km).

In the idea transformation embodiment of the present invention, at least one, and in particular each converter in the network has a geographically exclusive market relative to at least one of their manufacturing/production facilities, and the plurality of converters together have a combined geographic market that is larger than the geographically exclusive market of any one converter. In such a situation, the converters may realize increased demand for products they produce which incorporate the item of intellectual property, because it is available over a larger geographic market. Correspondingly, the supplier may realize an increase in the sale of plastic material to the converters in the network.

In the idea transformation embodiment of the present invention, each converter has a geographic market, which may also be a geographically exclusive market and/or a geographically limited market, or neither a geographically exclusive market nor a geographically limited market. At least one converter, and less than all of the converters, may refuse to take a license for the item of intellectual property, in which case the method of the present invention further comprises redistributing at least a portion of the refusing licensee's geographic market to (or amongst) one or more of those converters who have licensed the item of intellectual property (i.e., the licensing converters, or accepting licensees), but only as to that item of intellectual property. The refusing licensee's geographic market may be redistributed to (or amongst) one or more, but typically less than all of the accepting licensees. Some of the accepting licensees may not wish to ship product into the refusing licensee's geographic market, for reasons including, for example, prohibitively high shipping costs and lack of surplus capacity.

A converter within the network, for purposes of illustration, may not be able or wish to take a license to a particular item of intellectual property for reasons including, but not limited to, a lack of surplus capacity, for want of proper machinery, local environmental regulations and/or conflicts arising from contractual arrangements with other parties. When one or more converters is a refusing licensee, the remaining accepting licensees, the supplier and the idea submitting converter have an interest in distributing product incorporating the item of intellectual property into the refusing licensee's geographic market, for purposes of maximizing product orders for the accepting licensees, sale of plastic material by the supplier to the accepting licensees and royalties paid to the idea submitting converter. The geographic market redistribution step/option may be agreed to in advance in the network agreement between the supplier and the converters, and/or in the licensing contract between the supplier and the converters.

The supplier may, in the idea transformation embodiment of the present invention, obtain proprietary protection for the item of intellectual property, which is licensed to the converters. The form of proprietary protection may include, for example, copyright protection, trademark protection, patent protection and/or trade secret protection. The proprietary protection may be owned by the supplier and/or the converter who submitted the idea. Typically, the proprietary protection will be at least partially owned by the supplier, due to the supplier's contributions towards transforming the idea into an item of intellectual property as discussed previously herein, and the costs incurred by the supplier in securing the proprietary protection. The forms of proprietary protection may be described in further detail in accordance with those descriptions and examples as provided previously herein.

Costs associated with the supplier obtaining one or more forms of proprietary protection for the item of intellectual property may be born solely by the supplier, solely by the converter who submitted the idea, or shared by the supplier and the converter who submitted the idea. For example, at least a portion of the costs of obtaining proprietary protection may be passed directly on to the idea submitting converter, such as in the form of invoices. Alternatively, or in addition thereto, such costs may be deducted from the second portion of royalties that are forwarded to the idea submitting converter by the supplier, in which case, the first portion of royalties retained by the supplier would be correspondingly increased. Due to what are typically significant contributions, including monetary, creative and/or inventive contributions, made by the supplier in the idea transformation step, the supplier usually has at least a partial ownership interest in the resulting item of intellectual property. As such, at least a portion of the costs of obtaining intellectual property protection are typically born by the supplier.

In the idea transformation embodiment of the method of the present invention, each converter may be a manufacturer that practices a plastic molding method, such as thermoplastic molding methods and/or thermosetting molding methods (e.g., reaction injection molding). In particular, the molding method may be a thermoplastic molding method including, for example, injection molding, compression molding, vacuum molding, rotational molding, blow molding, thermoforming and combinations thereof.

Unless otherwise stated, all terms used herein and in the claims with regard to the idea transformation embodiment of the method of the present invention, are as described previously herein. The item of intellectual property that results from transformation of the converters' idea, for example, may be as described previously herein. In particular, the resulting item of intellectual property may be any form of intellectual property, including for example, copyrights, trademarks, patents, trade secretes and combinations of two or more thereof. In an embodiment of the present invention, the item of intellectual property, resulting from transformation of the idea, is selected from processes (e.g., molding processes), machines (e.g., molds and molding equipment), articles of manufacture (e.g., molded articles), compositions of matter (e.g., additives) and combinations thereof.

The plastic material sold to the converters by the supplier, in the idea transformation embodiment of the method of the present invention, may be as described previously herein. The plastic material that is sold by the supplier to the converters includes, but is not limited to, thermosetting resin components, thermosetting resin compositions, thermoplastic resins, thermoplastic resin compositions, and/or additives that may be used with thermosetting and/or thermoplastic resins and resin compositions. The converters may purchase the plastic material directly from the supplier or from an intermediate party, such as a distributor. The thermosetting resin components, thermoplastic resins, thermoplastic resin compositions, and additives may be further described in accordance with the descriptions and specific examples as recited previously herein.

The plastic material sold by the supplier and purchased by the converters may be a subject of the item of intellectual property that results from the idea transformation step. For example, a converter may submit an idea for a particular molded article requiring certain physical and/or chemical properties. During the idea transformation step, the supplier may develop a new resin or resin composition (e.g., a new thermoplastic resin or thermoplastic resin composition) that provides the required physical and/or chemical properties. The supplier may then license the newly developed resin and/or resin composition to the converters. When the plastic material sold by the supplier is a subject of the item of intellectual property, the supplier will typically own the item of intellectual property to the exclusion of the idea submitting converter. Sole ownership by the supplier is more particularly the case when the submitted idea does not relate to or touch upon plastic materials, but nevertheless leads to the development of a new plastic material. For example the submitted idea may relate to a molded article having certain physical properties, which the new resin provides, as discussed previously herein. When the plastic material sold by the supplier is a subject of the item of intellectual property, the supplier may still provide the idea submitting converter with the second portion of royalties as compensation for submitting the idea, and/or as an incentive to generate additional idea submissions by that converter and the other converters in the network, as discussed previously herein.

The present invention has been described with reference to specific details of particular embodiments thereof. It is not intended that such details be regarded as limitations upon the scope of the invention except insofar as and to the extent that they are included in the accompanying claims.

What is claimed is:

1. A business method comprising:
(a) forming a network comprising,
(i) a supplier of at least one plastic material, and
(ii) a plurality of converters, each converter agreeing to purchase at least one plastic material from said supplier;
(b) taking a license, by said supplier, for an item of intellectual property from an intellectual property owner, said intellectual property owner being other than said supplier;
(c) sublicensing, by said supplier, said item of intellectual property to each converter;
(d) collecting, by said supplier, royalties from each converter for each converter's use of said item of intellectual property sublicensed to them;
(e) retaining, by said supplier, a first portion of royalties; and
(f) forwarding, by said supplier, a second portion of royalties to said intellectual property owner.

2. The method of claim 1 wherein sublicensing said item of intellectual property to each converter allows each converter to produce a product, further wherein at least one of,
(i) said product comprises at least one plastic material purchased by each converter from said supplier, and
(ii) said product is prepared with at least one plastic material purchased by each converter from said supplier.

3. The method of claim 2 wherein said product is produced substantially uniformly by each converter.

4. The method of claim 1 wherein said intellectual property owner is at least one of said plurality of said converters and less than all of said plurality of said converters, and said item of intellectual property is sublicensed to each
converter who is not an owner of said item of intellectual property.

5. The method of claim 1 wherein in the absence of said network, said intellectual property owner would not license said item of intellectual property to all of said plurality of converters.

6. The method of claim 1 further comprising at least one of,
providing, by said supplier, marketing analysis results to at least one of said plurality of converters,
developing, by said supplier, at least one new market for at least one of said plurality of said converters,
promoting, by said supplier, a product made by at least one of said plurality of converters, and
providing, by said supplier, technical support for said item of intellectual property to at least one of said plurality of converters.

7. The method of claim 1 wherein said plastic material is selected from the group consisting of thermosetting resin components, thermosetting resin compositions, thermoplastic resins, thermoplastic resin compositions, thermosetting resin additives, thermoplastic resin additives and combinations thereof.

8. The method of claim 1 wherein each converter is a manufacturer practicing a thermoplastic molding method.

9. The method of claim 8 wherein said thermoplastic molding method is selected from the group consisting of injection molding, compression molding, vacuum molding, rotational molding, blow molding, thermoforming and combinations thereof.

10. The method of claim 1 wherein said sublicense is provided exclusively to said plurality of said converters.

11. The method of claim 1 wherein said plastic material is not a subject of said item of intellectual property.

12. The method of claim 1 wherein at least one converter produces a product, said product incorporating said item of intellectual property, said product being economically costly to ship, and each converter that produces said product having a geographically limited market as to said product relative to at least one manufacturing facility.

13. The method of claim 12 wherein said product has a property that renders it economically costly to ship, said property being selected from the group consisting of size, weight and combinations thereof.

14. The method of claim 12 wherein said geographically limited market has an area of 31,000 square miles to 283,000 square miles.

15. The method of claim 1 wherein each converter has a geographically exclusive market relative to at least one manufacturing facility, said plurality of converters having a combined geographic market, said combined geographic market being larger than the geographically exclusive market of any one converter.

16. The method of claim 1 wherein each converter has a geographic market, at least one converter and less than all converters is a refusing sublicensee who refuses the sublicense of said item of intellectual property, each converter that takes the sublicense being an accepting sublicensee, said method further comprising redistributing said refusing sublicensee's geographic market to at least one accepting sublicensee only as to said item of intellectual property.

17. The method of claim 1 further comprising obtaining, by said supplier, proprietary protection for said item of intellectual property.

18. The method of claim 17 wherein said proprietary protection for said item of intellectual property comprises at least one patent.

19. The method of claim 1 further comprising transforming, by said supplier, said item of intellectual property into a transformed item of intellectual property, and sublicensing said transformed item of intellectual property to each converter.

20. The method of claim 19 further comprising obtaining, by said supplier, proprietary protection for said transformed item of intellectual property.

21. The method of claim 20 wherein the proprietary protection for said transformed item of intellectual property comprises at least one patent.

22. The method of claim 1 wherein said item of intellectual property is selected from the group consisting of processes, machines, articles of manufacture, compositions of matter and combinations thereof.

23. A business method comprising:
(a) forming a network comprising,
(i) a supplier of at least one plastic material, and
(ii) a plurality of converters, each converter agreeing to purchase at least one plastic material from said supplier;
(b) collecting, by said supplier, at least one idea from at least one of said plurality of converters;
(c) transforming, by said supplier, said idea into an item of intellectual property;
(d) licensing, by said supplier, said item of intellectual property to said plurality of converters,
(e) collecting, by said supplier, royalties from each converter for each converter's use of said item of intellectual property licensed to them;
(f) retaining, by supplier, a first portion of royalties; and
(g) forwarding, by the supplier, a second portion of royalties to each converter that provided said idea to said supplier.

24. The method of claim 23 wherein licensing said item of intellectual property to each converter allows each converter to produce a product, further wherein at least one of,
(i) said product comprises at least one plastic material purchased by each converter from said supplier, and
(ii) said product is prepared with at least one plastic material purchased by each converter from said supplier.

25. The method of claim 24 wherein said product is produced substantially uniformly by each converter.

26. The method of claim 23 further comprising obtaining, by said supplier, proprietary protection for said item of intellectual property.

27. The method of claim 23 wherein said item of intellectual property is selected from the group consisting of processes, machines, articles of manufacture, compositions of matter and combinations thereof.

28. The method of claim 23 wherein said plastic material is selected from the group consisting of thermosetting resin components, thermosetting resin compositions, thermoplastic resins, thermoplastic resin compositions, thermosetting resin additives, thermoplastic resin additives and combinations thereof.

29. The method of claim 23 wherein each converter is a manufacturer practicing a thermoplastic molding method.

30. The method of claim 29 wherein said thermoplastic molding method is selected from the group consisting of injection molding, compression molding, vacuum molding, rotational molding, blow molding, thermoforming and combinations thereof.

31. The method of claim 23 wherein said item of intellectual property is exclusively licensed to said plurality of converters.

32. The method of claim 23 wherein said transforming step further comprises subjecting, by said supplier, said idea to research and development,
thereby transforming, by said supplier, said idea into said item of intellectual property.

33. The method of claim 23 wherein a plurality of ideas are collected from at least one converter, and said transforming step further comprises,
evaluating, by said supplier, at least one idea collected from at least one of said plurality of converters,
identifying, by said supplier, at least one viable idea, and
subjecting, by said supplier, said viable idea to research and development,
thereby transforming, by said supplier, said viable idea into said item of intellectual property.

34. The method of claim 23 wherein at least one converter produces a product, said product incorporating said item of intellectual property, said product being economically costly to ship, and each converter that produces said product having a geographically limited market as to said product relative to at least one manufacturing facility.

35. The method of claim 34 wherein said product has a property that renders it economically costly to ship, said property being selected from the group consisting of size, weight and combinations thereof.

36. The method of claim 35 wherein said geographically limited market has an area of 31,000 square miles to 283,000 square miles.

37. The method of claim 23 wherein each converter has a geographically exclusive market relative to at least one manufacturing facility, said plurality of converters having a combined geographic market, said combined geographic market being larger than the geographically exclusive market of any one converter.

38. The method of claim 23 wherein each converter has a geographic market, at least one converter and less than all converters is a refusing licensee who refuses the license of said item of intellectual property, each converter that takes the license being an accepting licensee, said method further comprising redistributing said refusing licensee's geographic market to at least one accepting licensee only as to said item of intellectual property.

39. The method of claim 23 wherein said plastic material is a subject of said item of intellectual property.

40. The method of claim 23 further comprising at least one of,
providing, by said supplier, marketing analysis results to at least one of said plurality of converters,
developing, by said supplier, at least one new market for at least one of said plurality of said converters,
promoting, by said supplier, a product made by at least one of said plurality of converters, and
providing, by said supplier, technical support for said item of intellectual property to at least one of said plurality of converters.
